(19) United States
(12) Patent Application Publication
(10) Pub. No.: US 2020/0202309 A1
(43) Pub. Date: Jun. 25, 2020

(54) EFFICIENT METHOD AND SYSTEM FOR PROVIDING DIGITAL RECEIPTS

(71) Applicant: Visa International Service Association, San Francisco, CA (US)

(72) Inventors: David Whitelaw, San Francisco, CA (US); Steven Leitman, San Francisco, CA (US); Paul Spaeth, Half Moon Bay, CA (US); Aashish Bhargava, Mountain View, CA (US); Sameer Govila, Atherton, CA (US)

(21) Appl. No.: 16/609,181

(22) PCT Filed: May 11, 2018
(86) PCT No.: PCT/US2018/032428

§ 371 Date: Oct. 28, 2019

Related U.S. Application Data
(60) Provisional application No. 62/505,675, filed on May 12, 2017.

(51) Int. Cl. G06Q 20/04; G06Q 20/40; G06Q 20/32

(52) U.S. Cl. CPC G06Q 20/0453; G06Q 20/3221; G06Q 20/401

(57) ABSTRACT

A method and system for efficiently providing digital receipts is disclosed. Digital receipts can be provided to a user in real-time and on-demand, via a communication device operated by the user. The user can use the communication device to request a digital receipt or other transaction information. This request can be formatted as an API call and transmitted to a processing server, which can then query a database and request transaction information from a resource provider in order to produce the digital receipt. The digital receipt can be transmitted back to the user via the communication device, or to an authorizing entity, which can then present the digital receipt to the user

### CROSS-REFERENCE TO RELATED APPLICATIONS

This application is a non-provisional of and claims the benefit of the filing date of U.S. provisional application No. 62/505,675, filed on May 12, 2017, which is herein incorporated by reference.

### BACKGROUND

Most, if not all banks, issuing entities, or authorizing entities provide a statement to their customers. Such statements include information on the different transactions the customer participated in, the amount of money the customer spent, and the name of any resource providers participating in the transaction. Increasingly, banks have moved from monthly statements to digital statements, which can be accessed by a consumer at any time via a computer or mobile device.

Many consumers appreciate digital statements, as they provides them with a convenient way to check for fraudulent or incorrect transactions. However, often times the statement does not provide enough information for the consumer to verify the accuracy of the transactions listed on the statement. Frequently a consumer is left pondering whether or not a particular transaction is fraudulent or legitimate. This in turn increases the amount of “requests for copy,” requests to a merchant verifying that they have signed receipts. In conventional systems, merchants and consumers collectively spend an inordinate amount of time verifying transactions.

In addition, storing receipts is difficult and may not be practical in many instances. For example, conventional receipt storages systems can store receipts in databases. Merchants may store their receipts, but they are of limited value to consumers, because consumers purchase goods from more than one merchant. Users can load their own receipts into their own receipt database. However, this requires the user to remember to upload receipts. This is not only time consuming, but it can be impractical given the number of merchants that a typical consumer interacts with.

Embodiments of the invention address these and other problems individually and collectively.

### SUMMARY

Embodiments of the invention include improved systems and methods for obtaining and storing receipts.

One embodiment is directed to a method of providing digital receipts. The method may be performed by a processing server in communication with a computing device and a receipt management server. The method includes receiving a digital receipt request from the computing device. The computing device may be a communication device of a user or an authorizing entity server of an authorizing entity. The digital receipt request being for a digital receipt associated with a transaction with a resource provider. The digital receipt request includes one or more transaction elements associated with the transaction. For example, the one or more transaction elements can include a transaction data, a transaction amount, a brief description of the transaction, a resource provider identifier, and a transaction type identifier. The method further includes determining a resource provider identifier based on the one or more transaction elements. The resource provider identifier may be determined based on a resource provider identifier, which may be one of the one or more transaction elements.

The method further includes obtaining resource provider information associated with the resource provider using the resource provider identifier. The resource provider identifier may be obtained by sending a resource provider information request including the resource provider identifier to a data center. The resource identifier may not uniquely define a particular resource provider or a particular location of a resource provider. The data center may aggregate and organize various sources of resource provider information and use that information to identify a particular resource provider based on the resource provider identifier. The method may further include receiving a resource provider information response from the data center including the resource provider information. The obtaining of the resource provider information can be based on the receiving of the resource provider information response.

The method further includes determining a receipt management server associated with the resource provider using the resource provider identifier. The receipt management computer may be determined using a resource provider routing table stored at the processing server. The receipt management computer may be determined by sending a request to a directory server that maintains the resource provider routing table instead of the processing server. The receipt management server may maintain digital receipt information for one or more resource providers.

The method further includes sending a receipt data request to the receipt management server. The receipt data request can including the one or more transaction elements. The receipt management server may use the one or more transaction elements to identify a particular transaction by comparing the one or more transaction elements to stored transaction data. The method further includes receiving receipt data from the receipt management server. The receipt data can include a plurality of data fields describing one or more goods or services associated with the transaction. The receipt management server may provide the receipt data according to a set of rules associated with the resource provider and/or based on an access level of the receipt data request. For instance, additional receipt data may be provided to an authorizing entity compared to a user's communication device. In another example, additional receipt data may be provided in response to a transaction dispute compared to a user selection a transaction on their statement.

The method further includes generating a digital receipt element based on the resource provider information and the receipt data. The digital receipt element may be an image (e.g., a Joint Photographic Experts Group “.jpg” file, a Portable Network Graphics “.png” file, etc.) or an image data object (e.g., a data file capable of including embedded images, such as a Portable Document Format “.pdf” file, a document “.doc” file, a Hypertext Markup Language “.html” file, etc.”). The digital receipt element may also be a text file (e.g., a comma-separated values “.csv” file, a text “.txt” file, an Extensible Markup Language “xml” file, etc.) or other suitable data format.

The method further includes sending the digital receipt element to the computing device. The processing server may host a webpage for the digital receipt element and send the digital receipt element via the webpage. In this example, the processing server can store an image or image data object generated from the digital receipt element. Then, the processing server can delete the image or image data object, after the sending of the digital receipt element, based on an expiration condition (e.g., after a predetermined amount of time or after a predetermined amount of times that the image or image data object is accessed or sent).

The computing device may provide a digital statement to a communication device of a user via a website or software application. The communication device may be a mobile phone, tablet, laptop computer, desktop computer, etc. The computing device can receive a selection of the transaction via a user interface of the website or software application. Then, a computing device can determine the one or more transaction elements based on a transaction identifier of the transaction. The transaction identifier may be set by an authorizing entity at the time when the transaction was authorized. At the time of the transaction (e.g., prior to completion of the transaction), the authorizing entity server may receive an authorization request for the transaction and authorize the transaction, thereby enabling the resource provider to complete the transaction. The transaction identifier may not uniquely identify the transaction out of all transactions, but the transaction identifier may uniquely identify the transaction within the transactions authorized by the authorizing entity.

The processing server may also determine a digital receipt capability of the resource provider using the resource provider identifier. The processing server may maintain a resource provider capability table that indicates whether a particular resource provider is capable of providing digital receipts (e.g., whether the receipt management server associated with the resource provider is configured account to an API for providing receipt data in response to receipt data requests).

Another embodiment of the invention is direct to a processing server programmed to perform the above-noted method.

Further details regarding embodiments of the invention can be found in the Detailed Description and the Figures.

### BRIEF DESCRIPTION OF THE DRAWINGS

FIG. 1 shows a block diagram of a digital receipt system, according to an embodiment of the invention.

FIG. 2 shows a message flow diagram for providing digital receipts, according to an embodiment of the invention.

FIG. 3 shows a message flow diagram for providing digital receipts, according to another embodiment of the invention.

FIG. 4 shows user interfaces on a communication device for a conventional digital statement and conventional transaction details available from a digital statement.

FIG. 5 shows user interfaces on a communication device for a digital statement providing digital receipts, according to an embodiment of the invention.

FIG. 6 shows user interfaces on a communication device for a digital statement providing digital receipts, according to an embodiment of the invention.

### DETAILED DESCRIPTION

A consumer may access a website or software application provided by an authorizing entity (e.g., a bank or issuer) to view a digital statement of transactions on their account. The consumer may review the statement for fraudulent or incorrect transactions. However, conventional digital statements often do not provide sufficient information for the consumer to verify the accuracy of the transactions listed on the statement. For instance, the brief description of the transaction provided on the statement may merely be a code or identifier of a processor (e.g., “PayPal” or “Square”). Such brief descriptions may not identify the resource provider. While conventional account statements provide a transaction date and a transaction amount in addition to the brief description, this information alone may not be sufficient for the consumer determine whether the transaction is fraudulent or legitimate.

To assist in reviewing account statements, some consumers may keep organized records of their physical (e.g., paper) and digital receipts (e.g., via email or text message). For instance, consumers may collect and store boxes of physical receipts and organize digital receipts using software applications (e.g., receipt scanning software). However, these tactics are not infallible. It is not uncommon for consumers to lose receipts or for resource providers to not provide receipts at all. For instance, a consumer may make several purchases in a shopping trip and accidentally throw away one of the receipts. In another example, a resource provider's receipt printing machine may be out of operation and the consumer may not have time to wait for the resource provider to fix the printing machine. In another example, a consumer may order an item online and either not receive order confirmation (e.g., by email) or receive an order confirmation that does not include receipt information, such as a description of the items, their prices, and quantities. Furthermore, many items ordered online are delivered without printed receipts included in the packaging. Thus, despite the best efforts of the most prudent consumers, conventional receipt management systems and methods are not be able to keep accurate receipt records for all transactions on their account.

Consequently, a consumer reviewing their account statement may need to call a customer service representative of the authorizing entity to inquire further details on a questionable transaction. While the authorizing entity may have more details regarding the transactions on the state (e.g., transaction information used in determining whether to authorize that transaction), the authorizing entity may still not have enough information for the consumer to determine whether the transaction is fraudulent or legitimate. For example, the transaction may be with a resource provider that the customer regularly shops at, but the consumer may think that the transaction amount is larger than it should be. Thus, another disadvantage of conventional systems is that the consumer may not be able to recognize a transaction legitimately made by the consumer. This situation can result in increased “requests for copy” (e.g., a request to a resource provider to verify that they have signed receipts for a transaction). This lack of information on the consumer's statement also leads to an increase in consumer calls to their authorizing entity's service representatives. Overall, an inordinate amount of time is wasted in attempting to verify transactions that could have been verified if more information been available to the consumer and/or the authorizing entity.

To overcome the disadvantages of conventional systems, embodiments of the present invention are directed to methods and systems for providing digital receipts to a user on their digital account statement provided by their transaction authorizing entity. A consumer can review their online statement, select a transaction, and view a digital receipt for the transaction. The digital receipt can be provided by the authorizing entity using information received from the resource provider. The digital receipt may be an image of the receipt printed by the resource provider at the time of the transaction, or similar to it. The digital receipt may also be generated based on receipt data provided by the resource provider. The digital receipt can also include additional information indicating the name and location of the resource provider. The consumer can also view a map showing the resource provider's street address. The consumer may also view digital receipts of other transactions performed on the same day in order to jog their memory. Thus, digital receipts enable the consumer to have sufficient information in order to verify whether a transaction listed on their account statement is fraudulent or legitimate. Furthermore, since the digital receipts are linked to transactions on their account statement, the consumer can be sure that all receipts are accounted for.

As discussed above, conventional systems have the disadvantage that consumers are often not provided with sufficient information to verify the accuracy of the transactions listed on the account statement and this deficiency cannot be overcome through diligent collection of physical and digital receipts. However, the embodiments described herein overcome these disadvantages by providing digital receipts having sufficient information to enable the consumer to verify the accuracy of the transactions, reducing time and costs to consumers, authorizing entities, and resource providers in performing transaction verification, “requests for copy,” and dispute management. Further advantages of the embodiments are described below.

Prior to discussing specific embodiments of the invention, some terms may be described in detail.

A “user” can be a person or thing that employs some other thing for some purpose. A user may include an individual that may be associated with one or more personal accounts and/or mobile devices. The user may also be referred to as a cardholder, account holder, or consumer in some embodiments.

A “communication device” may comprise any suitable computing device that can be used for communication. A communication device may provide remote or direct communication capabilities. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of communication devices include desktop computers, videogame consoles, mobile phones (e.g., cellular phones), PDAs, tablet computers, net books, laptop computers, personal music players, hand-held specialized readers, etc. Further examples of communication devices include wearable devices, such as smart watches, fitness bands, ankle bracelets, rings, earrings, etc., as well as automobiles with remote or direct communication capabilities. A communication device may comprise any suitable hardware and software for performing such functions, and may also include multiple devices or components (e.g., when a device has remote access to a network by tethering to another device—i.e., using the other device as a modem—both devices taken together may be considered a single communication device). A communication device may be referred to as a computing device.

A “resource” is something that may be used or consumed by an entity or transferred between entities. For example, the resource may be an electronic resource (e.g., stored data, received data, a computer account, a financial account, a network-based account, an email inbox), a physical resource (e.g., a tangible object, a building, a safe, or a physical location), or other electronic communications between computers (e.g., a communication signal corresponding to an account for performing a transaction).

A “resource provider” may be an entity that can provide resources. Examples of a resource providers include a merchant website operator, a data storage provider, an internet service provider, a bank, a building owner, a governmental entity, etc.

A “merchant” may typically be an entity that engages in transactions and can sell goods or services, or provide access to goods or services. A merchant may operate in a physical storefront (e.g., brick and mortar) or they may operate a digital storefront (e.g., a website). A merchant may also sell goods or services through a third party aggregator that offers goods and services from a plurality of merchants. Merchants may provide receipts to customers along with the sale of a good or service. The receipt may be a printed receipt or a digital receipt. Digital receipts may be sent to the customer via email or text message. Merchants may provide detailed digital receipts to an authorizing entity of the consumer's account used to conduct the transaction via a processing server.

An “authorizing entity” is an entity which can authorize or approve transactions. An authorizing entity may typically refer to a business entity (e.g., a bank) that maintains an account for a user and is capable of authorizing transactions such as payment transactions, for example the purchase of goods or services. An authorizing entity may provide a statement of the account to the user listing the transactions on the account. An authorizing entity may enable a user to select a transaction on their statement to see a detailed digital receipt. The authorizing entity may request the digital receipt from a processing server that provides an API for requesting digital receipts.

A “statement” can include a periodic summary of activity with a beginning and an end date. A statement can include a list of transactions conducted on an account provided by an authorizing entity (e.g., an issuer). For each transaction, the statement may indicate a date of the transaction, a type of the transaction, a brief description of the transaction, and an amount of the transaction. The statement may be a digital statement provided via a website or a software application.

An “authorization request message” may be an electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CW (card verification value), a dCW (dynamic card verification value), a PAN (primary account number or “account number”), a payment token, a user name, an expiration date, etc. An authorization request message may also comprise “transaction information,” such as any information associated with a current transaction, such as the transaction amount, resource provider identifier, resource provider location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, resource provider must call the toll-free authorization phone number. The authorization response message may also include an authorization code, which may be a code that a credit card issuing bank returns in response to an authorization request message in an electronic message (either directly or through the transaction processing computer) to the resource provider's access device (e.g., POS equipment) that indicates approval of the transaction. The code may serve as proof of authorization.

The term “server computer” may include any suitable computing device that can provide communications to other computing devices and receive communications from other computing devices. For instance, a server computer can be a mainframe, a minicomputer cluster, or a group of servers functioning as a unit. In one example, a server computer may be a database server coupled to a Web server. A server computer may be coupled to a database and may include any hardware, software, other logic, or combination of the preceding for servicing the requests from one or more client computers. A server computer may comprise one or more computational apparatuses and may use any of a variety of computing structures, arrangements, and compilations for servicing the requests from one or more client computers. Data transfer and other communications between components such as computers may occur via any suitable wired or wireless network, such as the Internet or private networks.

A “processing server” may be a server computer designed or programmed to process requests made by other entities. This may include requests such as a request for transaction information or a digital receipt. The processing server may be in operative communication with a variety of entities in order to process requests. The processing server may provide an application programming interface (API) for processing requests. For example, a first API may be used to receive digital receipt requests from computing devices. The digital receipt requests may include one or more transaction elements that the processing server can use to determine a resource provider involved in the transaction. The processing server can determine a receipt management server that provides receipt management services for one or more resource providers. The processing server can then use a second API to send a receipt information request to the receipt management computer and can receive, in response, receipt data for the transaction associated with the one or more transaction elements. The processing server can generate one or more digital receipt elements based on the receipt data and provide the one or more digital receipt elements to the authorizing entity, for example.

A “digital receipt” may be an electronic representation of a receipt which could be issued during the course of a transaction between a resource provider and a user. A digital receipt may be based on one or more “digital receipt elements.” A digital receipt element may be an image or image data object (e.g., a pdf) of a physical or digital receipt created at the time of the transaction. The digital receipt elements may also include data indicating a list of items along with their prices, a subtotal, total, applicable taxes, authorization, a transaction ID, a transaction date, a transaction time, a posted date, a transaction type, a transaction method, a transaction number, the name of the resource provider, the address of the resource provider, the signature of the user, and/or some or all of the digits of a primary account number, such as the last four digits of a credit card number. Digital receipt elements may further include other information, such as notifications of a sale, advertisements, a bar code, a QR code, coupons, a savings amount, and/or images, indicia associated with the resource provider, resource provider, or a payment processing network such as VisaNet, or a message or statement in text from the resource provider, resource provider, or payment processing network. A digital receipt may be generated based on the one or more digital receipt elements and may be formatted different depending on the available digital receipt elements.

An “Application Programming Interface” (API) is a set of procedures, protocols, or tools for building software applications. An API may be used to build applications which allow communication between one or more entities. Examples of APIs include POSIX, and the C++ Standard Template Library. An “API call” is a communication between two software applications or computers made possible by an API. An API call could include a standardized method of requesting or delivering information between software applications, such as a client-side application and a server-side application according to the server-side API. An API call could take the form of an HTTP method, such as GET, POST, PUT, or DE. For example, a processing server may implement a first API used to receive digital receipt requests from computing devices. The digital receipt requests may include one or more transaction elements that the processing server can use to determine a resource provider involved in the transaction. A digital receipt response can include one or more digital receipt elements based on receipt data. The processing server may also implement a second API for requesting receipt data from receipt management computers. The receipt data requests can include the one or more transaction elements. The corresponding receipt data response can include the one or more digital receipt elements.

As used herein, the term “providing” may include sending, transmitting, making available on a web page, for downloading, through an application, displaying or rendering, or any other suitable method. In various embodiments of the invention, rule profiles, rule outcome frequencies, and rule outcome disposition frequencies may be provided in any suitable manner.

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “processor” may refer to any suitable data computation device or devices. A processor may comprise one or more microprocessors working together to accomplish a desired function. The processor may include a CPU that comprises at least one high-speed data processor adequate to execute program components for executing user and/or system-generated requests. The CPU may be a microprocessor such as AMD's Athlon, Duron and/or Opteron, etc.; IBM and/or Motorola's PowerPC; IBM's and Sony's Cell processor; Intel's Celeron, Itanium, Pentium, Xeon, and/or Xscale, etc.; and/or the like processor(s).

Messages communicated between any of the computers, networks, and devices described herein may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

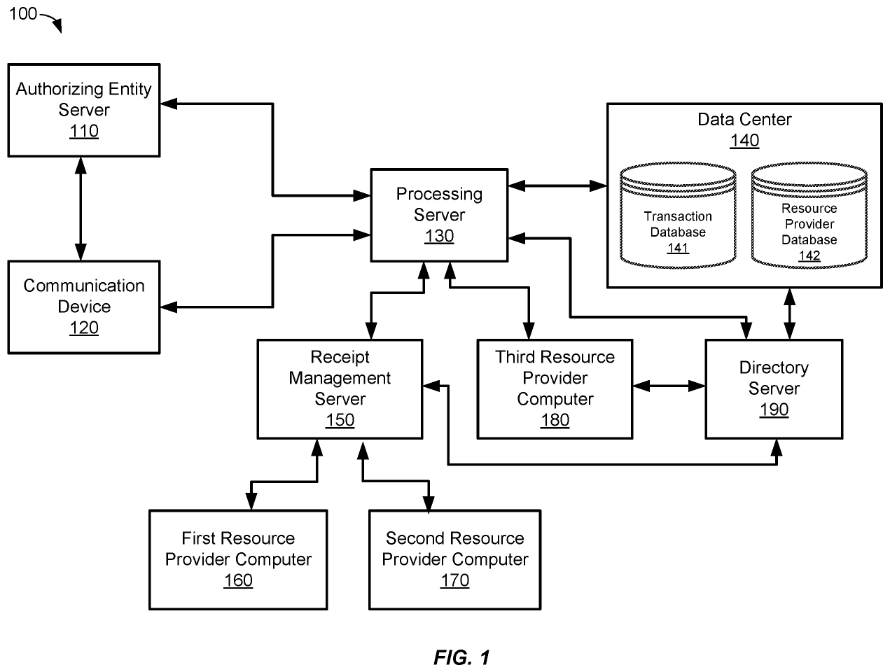

FIG. 1 shows a block diagram of a digital receipt system 100, according to an embodiment of the invention. The digital receipt system 100 includes an authorizing entity 110, a communication device 120, a processing server 130, a data center 140, a receipt management server 150, a first resource provider computer 160, a second resource provider computer 170, a third resource provider computer 180, and a directory server 190. Each of these entities may be capable of communicating over one or more communications network. For example, a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the entities, providers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

The communication device 120, which may be operated by a user. The communication device 120 may be a mobile phone, tablet, laptop computer, or desktop computer, for example. The communication device 120 is capable of running software, such as a web browser and a digital wallet application capable of providing digital statements.

The authorizing entity server 110 is capable of authorizing transactions on accounts. The authorizing entity 110 computer can communicate with the communication device 120 to provide a digital account statement to the user of the communication device 120 via a hosted webpage or a software application. The account statement may include a list of transactions made on an account of the user and a balance due for those transactions. Conventionally, the account statement may include a transaction date, a transaction amount, and a brief description of the merchant. Conventionally, the brief description of the merchant does not provide any specific details about the transaction (e.g., the time of the transaction or the goods or services purchased in the transaction). In some cases, the name of the merchant may not be recognized by the consumer, because the name of the merchant on the account statement may be a corporate name, whereas the consumer knows the merchant by its business name.

The processing server 130 is in communication with the authorizing entity 110, the communication device 120, the data center 140, the receipt management server 150, the third resource provider computer 180, and the directory server 190. The processing server is capable of providing the digital receipt element (e.g., an image, document, or file) to the authorizing entity 110 or communication device 120. The digital receipt element for a transaction is generated using receipt data obtained from a receipt management server that manages receipts for a particular resource provider involved in the transaction. In this embodiment, the receipt management server 150, which may be a third-party service provider, maintains transaction and receipt records for a first resource provider computer 160 and a second resource provider computer 170. The transaction and receipt records may be sent from the first resource provider computer 160 and the second resource provider computer 170 to the receipt management server 150 after each transaction or in a batch at predetermined increments. A third resource provider computer 180 does not use a service provider to maintain transaction and receipts data and instead acts as a receipt management server itself.

The data center 140 is in communication with the processing server 130 and the directory server 190. The data center 140 has a transaction database 141 and a resource provider database 142. In some embodiments, the transaction database 141 and the resource provider database 142 may be stored at the processing server 130 and the functionality of the data center 140 may be performed by the processing server. The transaction database 141 includes transaction information for transactions processed by a payment processing network (not shown). The transaction information stored in the transaction database 141 for each transaction can include a billing amount, a transaction amount, a transaction data, a transaction time, a resource provider identifier, an entry mode, “level 3 data” (e.g., flight departure date and city, and flight arrival date and city etc.) and any other details that are included in an authorization request or authorization response message used for authorizing that particular transaction.

The resource provider database 142 includes resource provider information associated with numerous resource providers. The resource provider information for a particular resource provider can include the resource provider identifier (which is also used for the transaction information in the transaction database 141), a store name, a resource provider name, a resource provider legal name, a resource provider category code, a resource provider category description, a resource provider street address, a city, state, postal code, and country code of the location that the resource provider is in, a phone number of the resource provider, and a website address (e.g., URL) of the resource provider.

In some embodiments, the data center 140 can be operated by an acquirer. An acquirer is typically an entity that manages and maintains accounts for a plurality of resource providers (e.g., merchants). Acquirers can house transaction data, as well as resource provider identifiers. It may also receive, periodically, detailed transaction data such as “level 3” data which might include information about the specific goods and services purchased by the users. Independent of embodiments of the invention, such information may be housed by the acquirer for dispute resolution purposes in the event that a consumer that interacted with a merchant of the acquirer wishes to dispute a transaction. In embodiments of the invention, the specific information about the resource providers and the transactions that they conducted can be used to generate receipts for consumers. This is not conventional and provides a unique and advantageous mechanism to obtain receipts data from many different merchants, without the need to contact each and every one of those merchants. As an acquirer can maintain the accounts of hundreds if not thousands of merchants, embodiments of the invention can allow the processing computer 130 to obtain receipt data for hundreds or thousands of merchants through a single API call rather than through hundreds or thousands of API calls. Further, a separate database need not be created to specifically house receipts data, since the information housed for a different purpose (e.g., dispute resolution) may be utilized to generate receipts.

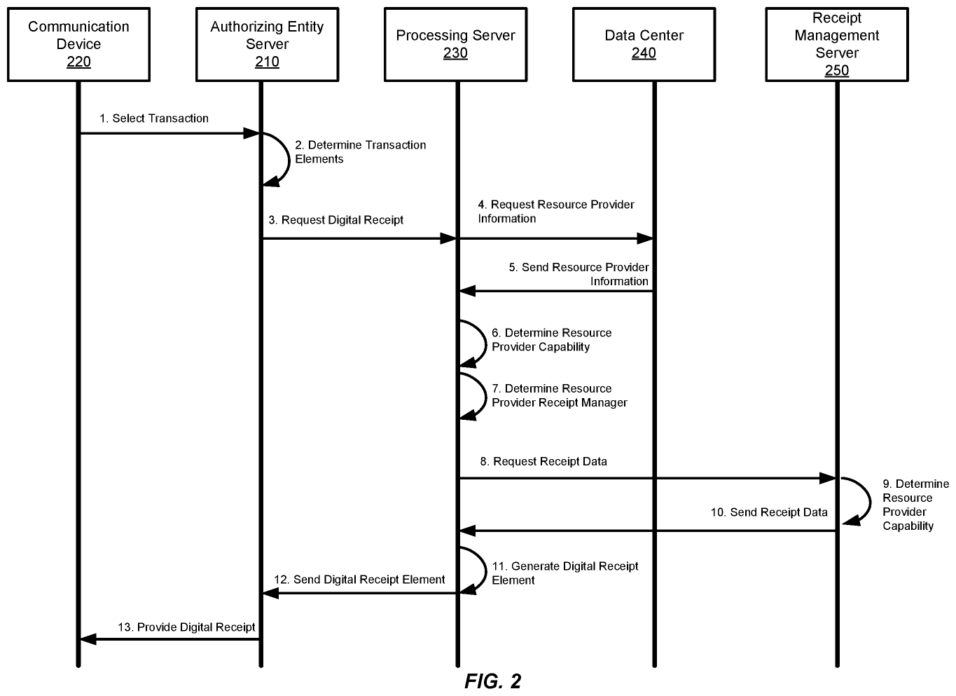

FIG. 2 shows a message flow diagram for providing digital receipts, according to an embodiment of the invention. The message flow diagram of FIG. 2 shows communication messages sent between a communication device 220, an authorizing entity server 210, a processing server 230, a data center 240, and a receipt management server 250. The communication device 220, authorizing entity server 210, processing server 230, data center 240, and receipt management server 250 may store the same information and perform the same functionality as those same entities described above with respect to FIG. 1.

At step 1, a user of the communication device 220 can browse a digital statement provided by the authorizing entity server 210 using a web browser or a software application. The user may click, tap on a link, or otherwise indicate an interest in seeing more information about a particular transaction using the user interface of the communication device 220 (e.g., pointing and clicking with a mouse or touching on a touch screen). The transaction selected by the user may be associated with a statement identifier that uniquely identifies that particular transaction among the transactions within the user's statement, or within all transactions maintained by the authorizing entity server 210. The statement identifier is included in a digital receipt request, enabling the authorizing entity to identify the selected transaction from among the transactions that it maintains. The communication device 220 sends the statement identifier of the selected transaction to the authorizing entity computer 210. The authorizing entity may maintain a table associating statement identifiers with a particular transaction, which can be used to determine the transaction elements for the transaction. This digital receipt request may indicate to the authorizing entity computer 210 that the user is interested in obtaining a digital receipt. In some embodiments, the authorizing entity server 210 determines the statement identifier itself based on which link is selected on the communication device 220, instead of the communication device sending the statement identifier.

At step 2, the authorizing entity server 210 determines a plurality of transaction elements associated with the selected transaction. The plurality of transaction elements can include identification information such as a service code, a card verification value, a dynamic card verification value, a primary account number or account number, a payment token, a user name, an expiration date, a trace number, a reference number, etc. The plurality of elements can also include transaction information, such as the transaction amount, a resource provider identifier, a card acceptor identifier, a terminal identifier, a resource provider location, an acquirer bank identification number, and any available information identifying items being purchased.

At step 3, the authorizing entity server 210 sends a digital receipt request to the processing server 230 includes the one or more transaction elements of the plurality of transaction elements associated with the selected transaction. The digital receipt request can be made as an API call to the processing server 230 according to a digital receipts API provided by the processing server 230. The one or more transaction elements in the digital receipt request enable the processing server 230 to determine which resource provider was involved in the transaction. As discussed below, the one or more transaction elements in the digital receipt request also enables a receipt management computer associated with the resource provider to uniquely identify the selected transaction. In some embodiments, the one or more transaction elements can include a resource provider identifier or an acceptor identifier (identifying the resource provider) for the selected transaction. The one or more transaction elements can also include a trace number or a reference number. In addition, any number and combination of the identification information and transaction information listed above may be provided as is necessary for a particular receipt management computer. For example, the one or more transaction elements in a digital receipt request can include the resource provider identifier, the transaction date, the transaction amount, and the account number. In another example, for a larger resource provider with several locations, the one or more transaction elements in a digital receipt request can include the resource provider identifier, the resource provider location, the transaction date, the transaction amount, and the account number. In another example, the one or more transaction elements in a digital receipt request can include the resource provider identifier and a trace number or a reference number.

In addition to providing digital receipts, the processing server 230 can enhance the digital receipts by including additional information regarding the resource provider, such as a street address, map of the street address, phone number, website address, etc. The processing server 230 can obtain resource provider information based on the one or more transaction elements. To do this, the processing server 230 determines a resource provider identifier based on the one or more transaction elements. The resource provider identifier may be the same as or derived from the resource provider identifier included in the digital receipt request from the authorizing entity server 210.

At step 4, the processing server 230 can obtain the resource provider information by sending a resource provider information request including the resource provider identifier to the data center 240. The resource provider information request may also include the resource provider identifier. The resource provider information may be stored in a resource provider database. The resource provider database includes resource provider information associated with numerous resource providers. The resource provider information for a particular resource provider can include the resource provider identifier, a store name, a resource provider name, a resource provider legal name, a resource provider category code, a resource provider category description, a resource provider street address, a city, state, postal code, and country code of the location that the resource provider is in, a phone number of the resource provider, and a website address (e.g., URL) of the resource provider. The data center 340 can use resource provider identifier included in the resource provider information request to identify a particular resource provider based on the resource provider identifier stored in the resource provider database. At step 5, data center 240 sends the resource provider information to the processing server 230.

At step 6, the processing server 230 determines a resource provider capability of the resource provider. The resource provider capability can indicate whether the resource provider is capable of providing digital receipts (e.g., whether the resource provider has a receipt management server 250 capable of responding to digital receipt API calls from the processing server 230. The processing server 230 can maintain a resource provider capability table referencing resource processing identifiers with a YES or NO indication of whether they are capable of digital receipts. The capability information may be obtained during a registration process for the resource provider with the processing server 230. In this example, the resource provider associated with the transaction selected by the user is capable of providing digital receipts via the receipt management server 250.

At step 7, the processing server 230 determines a receipt management server associated with the resource provider. The processing server 230 can maintain a routing table indicating the network address of each resource management server and each of the resource providers associated with that particular resource management server. The routing table includes routing information for each resource provider that is capable of providing digital receipts.

At step 8, the processing server 230 sends a receipt data request to the receipt management server 250 associated with the resource provider identifier in the routing table. The receipt data request includes the one or more transaction elements received from the authorizing entity 210.

At step 9, the receipt management server 250 receives the receipt data request including the one or more transaction elements. The receipt management server 250 is capable of uniquely identifying the transaction by comparing the one or more transaction elements to stored transaction records for transactions conducted by the one or more associated resource providers that it maintains receipts for. After identifying the transaction, the receipt management server 250 determines receipt data for the identified transaction. The receipt data can include one or more of an email account of the resource provider, a device name of the consumer's device, an application source or browser type for online transactions, a type of authentication conducted, an item description, stock keeping unit information, an item artist/select, and item type, an item quantity, an item price, an item category, resource provider contact information (e.g., phone number and/or email address), a shipping tracking number, a website link, a link to the item cold, a message from the resource provider, an image associated with the transaction, such as a bar code or QR code, or an image of a printed or digital receipt, a sub total for the transaction, a tax amount for the transaction, and a tip amount for the transaction. At step 10, the receipt management server 250 can send the receipt data to the processing server 230.

In other embodiments, the processing server 230 may contact a resource provider such as the third resource provider 180 directly if it houses its own receipts data.

At step 11, the processing server 230 receives the receipt data from the receipt management server 250 (or directly from the resource providers) and generates a digital receipt element based on the resource provider information and the receipt data. The digital receipt element may be may be an image (e.g., a Joint Photographic Experts Group “.jpg” file, a Portable Network Graphics “.png” file, etc.) or an image data object (e.g., a data file capable of including embedded images, such as a Portable Document Format “.pdf” file, a document “.doc” file, a Hypertext Markup Language “.html” file, etc.”). The digital receipt element may also be a text file (e.g., a comma-separated values “.csv” file, a text “.txt” file, an Extensible Markup Language “xml” file, etc.) or other suitable data file. In some embodiments, the receipt data could be the same or similar to the receipt element.

At step 12, the processing server 230 sends the digital receipt element to the authorizing entity server 210. In some embodiments, the processing server 230 can provide the digital receipt element via a hosted webpage. In such embodiments, the processing server 230 provides a web address (e.g., URL) of the digital receipt element.

In some embodiments, the processing server 330 can briefly store the digital receipt element (e.g., the image or image data object) and then delete the digital receipt element from storage after the digital receipt element is provided via the hosted web page. In some embodiments, the processing server 330 may store the digital receipt element in short-term storage. The processing server 330 may delete the digital receipt element based on an expiration condition, such as an amount of time passing or a number of times that the digital receipt element has been accessed.

It is advantageous for the data processing server 330 to not store the digital receipt element because the number of transactions processed by the processing server 130 is very large (e.g., 150 million transactions per day) if the processing server 130 serves a hub or switch routing transactions between various authorizing entity computers (e.g., issuer computers) and transport computers (e.g., acquirer computers). Digital receipt elements may contain images, which consume a relatively large amount of storage space, as well as non-trivial amounts of text. It would be very difficult for a single server or computer system to handle such a large amount of data coming from thousands of merchants. To overcome this problem, embodiments of the invention can use a combination of different and distributed receipt data storage systems. Such receipt data storage systems may include the resource providers (e.g., the merchants), the acquirers (who may house transaction data for many merchants), and receipt management servers (which may store receipts for multiple merchants). Using this combination of storage systems, the processing server 330 need not store any receipt data, but may serve to pull receipt data from various pre-existing receipt data sources. Receipts can be generated on demand, via a user's monthly statement provided by the user's issuer. This architecture is also advantageous, because the resource providers (and their receipt management servers) are better able to scale their storage requirements along with the number of transactions that they conduct. Independent receipt storage systems are unable to anticipate the number of sales that might be conducted by the many thousands of existing merchants. Thus, it becomes possible to store data for generating digital receipts through proportionally distributed, data storage systems.

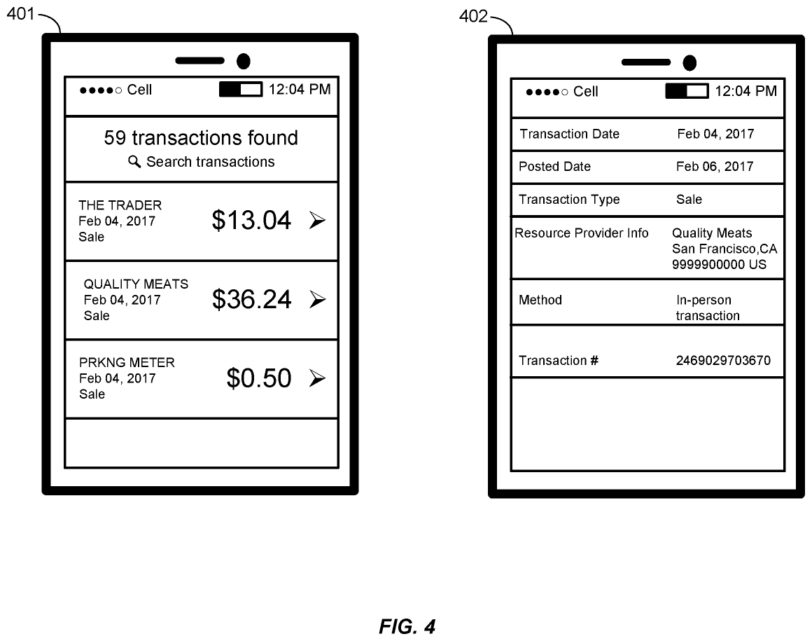

At step 13, the authorizing entity server 230 receives the digital receipt element from the processing server 230 and provides a digital receipt to the communication device 220. If the digital receipt element is an image or image data file, the authorizing entity can display the image itself. If the digital receipt element is a text, document, or data file including the receipt data, the authorizing entity server can generate a digital receipt based on the information included in the digital receipt element. The user interface of the communication device 220 is further described below with respect to FIGS. 4-6.

Some resource providers may not be capable integrating with the processing server API for providing receipt data for digital receipts and they may not have a receipt manager to perform this service for them. In such situations the processing server can obtain certain transaction information and certain resource provider information from the data center instead.

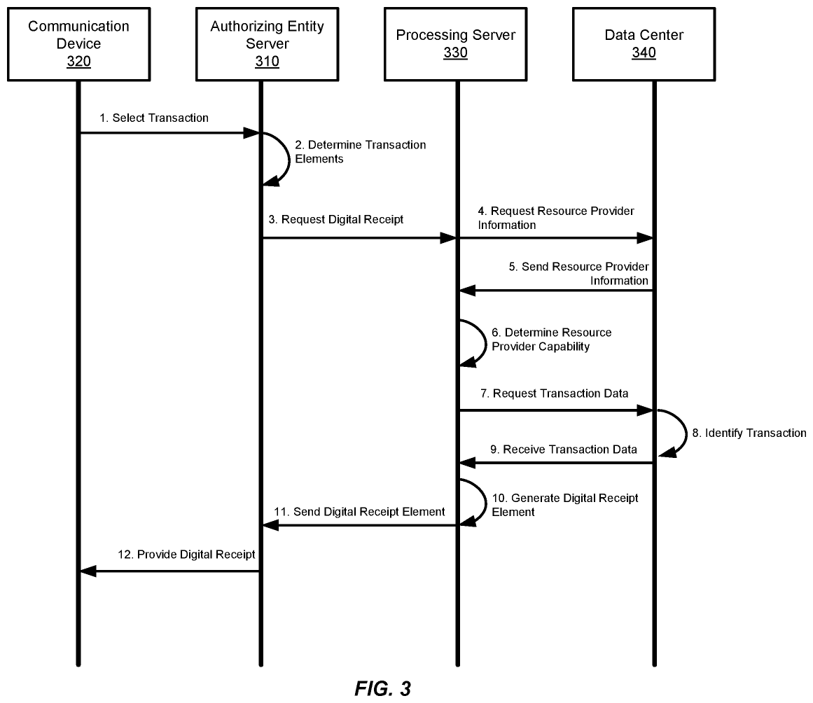

FIG. 3 shows a message flow diagram for providing digital receipts, according to an embodiment of the invention. The message flow diagram of FIG. 3 shows communication messages sent between a communication device 320, an authorizing entity server 310, a processing server 330, and a data center 340. The message flow of FIG. 3 does not include communication messages sent by a receipt management server. The communication device 320, authorizing entity server 310, processing server 330, and data center 340 may store the same information and perform the same functionality as those same entities described above with respect to FIG. 1.

In FIG. 3, steps 1-5 can be substantially similar to steps 1-5 in FIG. 2. The descriptions of those steps are incorporated herein, and need not be repeated for the sake of brevity.

At step 6, the processing server 330 determines a resource provider capability of the resource provider. The resource provider capability can indicate whether the resource provider is capable of providing digital receipts (e.g., whether the resource provider has a receipt management server 350 capable of responding to digital receipt API calls from the processing server 330. The processing server 330 can maintain a resource provider capability table referencing resource processing identifiers with a YES or NO indication of whether they are capable of digital receipts. The capability information may be obtained during a registration process for the resource provider with the processing server 330. In this example, the resource provider associated with the transaction selected by the user is not capable of providing digital receipts. That is, the resource provider does not have a resource management server providing digital receipt capability for them and is not capable of providing digital receipts themselves. In this situation, the processing server can request addition transaction data from the data center 340.

At step 7, the processing server 330 can send a transaction information request to the data center 340 including the one or more transaction elements. The data center 340 stores a transaction database that includes transaction information for transactions processed by a payment processing network (not shown). The transaction information stored in the transaction database for each transaction can include a billing amount, a transaction amount, a transaction data, a transaction time, a resource provider identifier, an entry mode, “level 3 data” (e.g., flight departure date and city, and flight arrival date and city etc.) and any other details that are included in an authorization request or authorization response message used for authorizing that particular transaction.

At step 8, the data center 340 receives the transaction information request including the one or more transaction elements. The data center 340 can compare the one or more transaction elements received in the transaction information request to the transaction information stored in the transaction database to identify the transaction selected by the user. The transaction information stored by the data center 340 can include additional details about the entities involved in the transaction compared to the transaction information maintained by the authorizing entity server 310. At step 10, the data center can send a transaction information response to the processing server 330 including the transaction information for the transaction retrieved from the transaction database.

At step 10, the processing server 330 receives the transaction data from the data center 340 and generates a digital receipt element based on the resource provider information and the receipt data. The digital receipt element may be an image (e.g., a Joint Photographic Experts Group “.jpg” file, a Portable Network Graphics “.png” file, etc.) or an image data object (e.g., a data file capable of including embedded images, such as a Portable Document Format “.pdf” file, a document “.doc” file, a Hypertext Markup Language “.html” file, etc.”). The digital receipt element may also be a text file (e.g., a comma-separated values “.csv” file, a text “.txt” file, an Extensible Markup Language “xml” file, etc.) or other suitable data file.

At step 11, the processing server 330 sends the digital receipt element to the authorizing entity server 310. In some embodiments, the processing server 330 can provide the digital receipt element via a hosted webpage. In such embodiments, the processing server 330 provides a web address (e.g., URL) of the digital receipt element.

In some embodiments, the processing server 330 can briefly store the digital receipt element (e.g., the image or image data object) and then delete the digital receipt element from storage after the digital receipt element is provided via the hosted web page. In some embodiments, the processing server 330 may store the digital receipt element in short-term storage. The processing server 330 may delete the digital receipt element based on an expiration condition, such as an amount of time passing or a number of times that the digital receipt element has been accessed.

At step 12, the authorizing entity server 330 receives the digital receipt element from the processing server 330 and provides a digital receipt to the communication device 320. If the digital receipt element is an image or image data file, the authorizing entity can display the image itself. If the digital receipt element is a text, document, or data file including the receipt data, the authorizing entity server can generate a digital receipt based on the information included in the digital receipt element. The user interface of the communication device 320 is further described below with respect to FIGS. 4-6.

Some embodiments may include a combination of steps describes with respect to FIG. 2 and FIG. 3. For example, the processing server can request receipt data from the receipt management server and also request transaction data from the data center.

FIGS. 4-6 show examples of user interfaces that may be displayed on a communication device of a user. These user interfaces are simplified for explanation purposes and may not be drawn to scale.

FIG. 4 shows user interfaces on a communication device for a conventional digital statement and conventional transaction details available from a digital statement. A first user interface 401 shows a conventional digital account statement provided by an authorizing entity. Conventionally, account statements will provide a transaction data, a transaction amount, and a brief description of the transaction. The brief description may, or may not indicate a resource provider that the transaction was conducted at. Conventionally, the brief description does not indicate the goods or services purchased in the transaction or the quantities, individual prices, the sub total before tax, or the amount of tax applied to the transaction.

Certain conventional account statements may also provide a second user interface 402 showing some additional transaction information. For example, a conventional account statement may further indicate the posting date of the transaction, the type of transaction, an address of the resource provider, a method of the transaction, and a transaction number. However, this additional transaction information in conventional statements does not include as much information as a receipt does. For instance, the additional transaction information shown in the second user interface 402 lacks a listing of individual items purchased in the transaction and their prices. Thus, this additional information may not be sufficient to enable a user to determine whether the transaction is fraudulent.

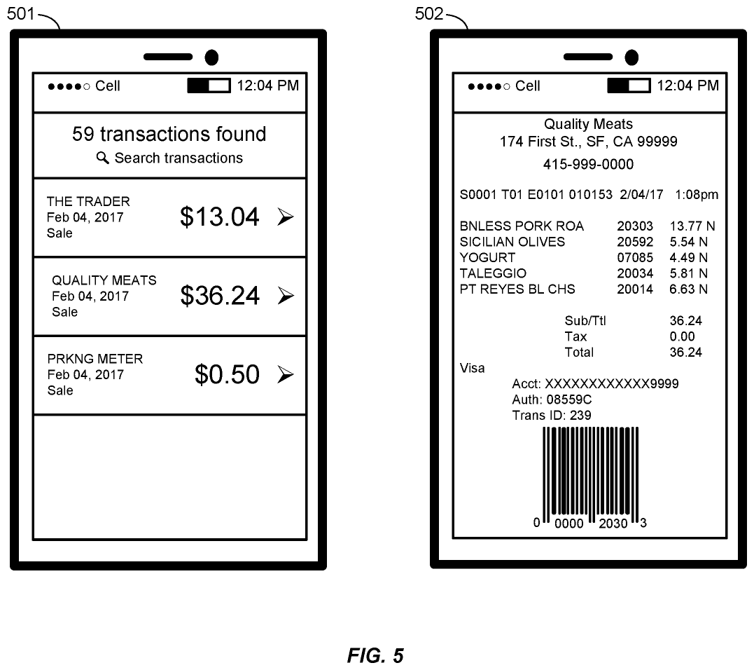

FIG. 5 shows user interfaces on a communication device for a digital statement providing digital receipts, according to an embodiment of the invention. A first user interface 501 shows a digital account statement provided by an authorizing entity. The digital account statement shown in the first user interface 501 may be similar to the conventional user interface 401 shown in FIG. 4. A first user interface 501 shows a digital account statement provided by an authorizing entity. The digital account statement shown in the first user interface 501 may be similar to the conventional user interface 401 shown in FIG. 4. However, when a user selects a transaction (e.g., by touching on a touch screen or by pointing with a mouse), a second user interface 502 displays a digital receipt that can be generated according to the method described above with respect to FIG. 2. The digital receipt includes the resource provider's name, street address, phone number, the date, the time of the transaction, individual items purchased in the transaction (five items in this example), the product numbers of the items (shown next to the item names), and the prices of the items. The digital receipt also includes the sub total before tax, the amount of tax, and the total transaction amount. The digital receipt also includes an indication of the account number used to conduct the transaction, and authorization reference number, and a transaction ID.

The digital receipt also includes an image, which is a bar code in this example. The bar code can be associated with one or more of the items purchased. In some examples, the digital receipt can include a bar code for each item. Having bar codes on digital receipts is advantageous because it enables a consumer to return a product to the resource provider even if they have lost their printed receipt. For example, if a consumer purchases an item of clothing, the resource provider may not be able to determine that the item was purchased from their store in particular without the receipt because other resource providers may sell the same item. For this reason, the resource provider may not accept the return without a receipt. An unfortunate consumer having lost their physical receipt can instead go online to their digital statement, identify the transaction, and print their digital receipt (or display it on their communication device). Thus, the consumer may return their item using digital receipts whereas they would not be able to do so using conventional systems. In some embodiments, the digital statement may further include a search bar that enables the user to search for transactions using a name of a resource provider or a name of an item, making it quicker to identify particular transactions.

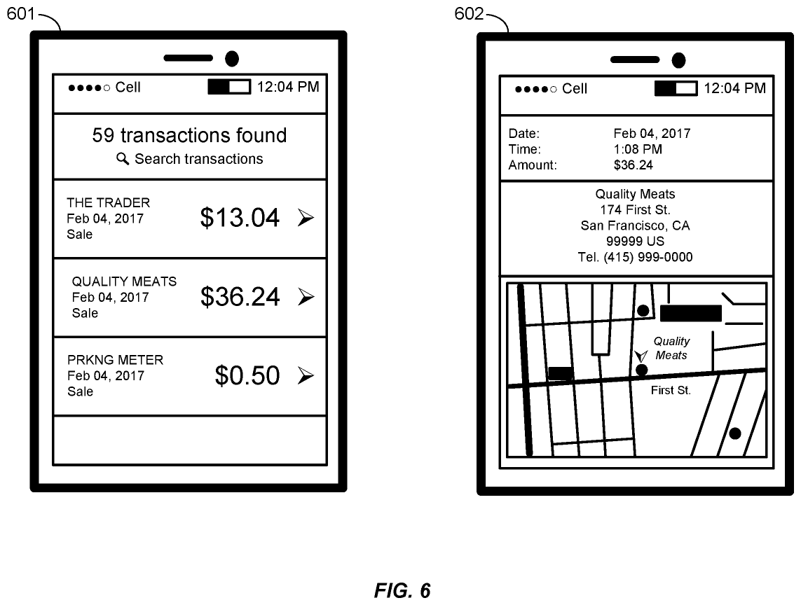

FIG. 6 shows user interfaces on a communication device for a digital statement providing digital receipts, according to an embodiment of the invention. However, when a user selects a transaction (e.g., by touching on a touch screen or by pointing with a mouse), a second user interface 602 displays a digital receipt that can be generated according to the method described above with respect to FIG. 3. The digital receipt includes the resource provider's name, street address, phone number, the date, the time of the transaction, and the transaction amount. The second user interface 602 also includes a map that shows the street location of the resource provider. In some embodiments, the digital receipt shown in the second user interface 502 of FIG. 5 may also include a map as shown in the second user interface 602 of FIG. 6. The map is advantageous because even if the resource provider is not capable of providing digital receipts including item information and prices, a map may still be helpful in jogging a user's memory while checking their account statement.

Embodiments of the invention present a number of advantages. As discussed above, conventional systems have the disadvantage that consumers are often not provided with sufficient information to verify the accuracy of the transactions listed on the account statement and this deficiency cannot be overcome through diligent collection of physical and digital receipts. However, the embodiments described herein overcome these disadvantages by providing digital receipts having sufficient information to enable the consumer to verify the accuracy of the transactions, reducing time and costs to consumers, authorizing entities, and resource providers in performing transaction verification, “requests for copy,” and dispute management. Further advantages of the embodiments are described below.

In addition, embodiments of the invention are advantageous because they proportionally distribute storage of digital receipt data among resource providers, overcoming storage difficulties due to the large amount of data. As discussed above, it is advantageous for the data processing server not to store the digital receipt elements at a single processing server, because the number of transactions processed by that processing server can be very large (e.g., 150 million transactions per day) and the digital receipt element may contain images, which consume a relatively large amount of storage space, as well as non-trivial amounts of text

In addition, users receive the benefit of an enhanced transaction experience. Providing digital receipts in a real-time and on-demand manner makes it easier for users to recognize legitimate and fraudulent transactions. Also, the users transactions are organized by date on their monthly statements, and this organization makes it easier for them to find receipts for their transactions. For example, users can often remember what month they conducted a transaction, or can do a search through their issuer's Website for a particular merchant to help locate a particular receipt. This capability does not exist in conventional systems. Further, methods and systems make recordkeeping easier for users, such as keeping records of transactions for returns, service, or tax purposes. Furthermore, providing digital receipts via their issuer's website or software application is more convenient and efficient for users checking for fraudulent transactions, compared to conventional receipt tracking methods and systems, since the user would be initiating a dispute through their issuer. There is no need for the user to compare between two separate lists of transactions (e.g., the issuer statement and their separate receipt management system).

Further, embodiments of the invention improve resource provider's omnichannel experience. Frequently resource providers experience some difficulty in managing records of transactions from different sources, such as in store, online, or by phone. By providing resource providers with a method of providing digital receipts, resource providers can utilize a single digital receipt system for any transaction channel.

Additionally, resource providers benefit from transaction dispute reduction. Since users have access to digital receipts or additional transaction information, they will be better able to identify fraudulent or legitimate transactions. In this way the number of false positives, or cases where users identify a legitimate transaction as a fraudulent one will decrease. This will in turn reduce the number of disputes over unrecognized transactions.

Authorizing entities also benefit from the method and system according to embodiments of the invention. Authorizing entities benefit from an enhanced user experience. Authorizing entities also benefit from reduced numbers of customer service calls and transaction disputes.

A computer system may be used to implement any of the entities or components described herein. Subsystems in the computer system are interconnected via a system bus. Additional subsystems include a printer, a keyboard, a fixed disk, and a monitor which can be coupled to a display adapter. Peripherals and input/output (I/O) devices, which can couple to an I/O controller, can be connected to the computer system by any number of means known in the art, such as a serial port. For example, a serial port or external interface can be used to connect the computer apparatus to a wide area network such as the Internet, a mouse input device, or a scanner. The interconnection via system bus allows the central processor to communicate with each subsystem and to control the execution of instructions from system memory or the fixed disk, as well as the exchange of information between subsystems. The system memory and/or the fixed disk may embody a computer-readable medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a,” “an,” or “the” is intended to mean “at least one,” unless specifically indicated to the contrary.

What is claimed is:

1. A method of providing digital receipts, comprising:
receiving, by a processing server, a digital receipt request from a computing device for a digital receipt associated with a transaction with a resource provider, the digital receipt request including one or more transaction elements associated with the transaction;
determining, by the processing server, a resource provider identifier based on the one or more transaction elements;
obtaining, by the processing server, resource provider information associated with the resource provider using the resource provider identifier;
determining, by the processing server, a receipt management server associated with the resource provider using the resource provider identifier;
sending, by the processing server, a receipt data request to the receipt management server, the receipt data request including the one or more transaction elements;
receiving, by the processing server, receipt data from the receipt management server;
generating, by the processing server, a digital receipt element based on the resource provider information and the receipt data; and
sending, by the processing server, the digital receipt element to the computing device.

2. The method of claim 1, wherein the receipt data includes a plurality of data fields describing one or more goods or services associated with the transaction, wherein the digital receipt element is an image or image data object, and wherein the method further comprises:
storing, by the processing server, the image or image data object; and
hosting, by the processing server, a webpage for the digital receipt element, wherein the sending of the digital receipt element is performed via the webpage.

3. The method of claim 2, further comprising:
deleting, by the processing server, the image or image data object, after the sending of the digital receipt element, based on an expiration condition.

4. The method of claim 1, wherein the receipt data includes a plurality of data fields describing one or more goods or services associated with the transaction, and wherein the computing device generates a digital receipt based on the resource provider information and the receipt data.

5. The method of claim 1, wherein the computing device provides a digital statement to a communication device of a user via a website or software application, wherein the computing device receives a selection of the transaction via a user interface of the website or software application, and wherein the computing device determines the one or more transaction elements based on a transaction identifier of the transaction.

6. The method of claim 1, further comprising:
determining, by the processing server, a digital receipt capability of the resource provider using the resource provider identifier, the digital receipt capability indicating whether the resource provider is capable of providing digital receipts or is not capable of providing digital receipts, wherein the determining of the receipt management server and the sending of the receipt data request occur in response to the digital receipt capability indicating that the resource provider is capable of providing digital receipts.

7. The method of claim 1, further comprising:
sending, by the processing server, a resource provider information request to a data center, the resource provider information request including the resource provider identifier; and
receiving, by the processing server, a resource provider information response from the data center including the resource provider information, wherein the obtaining of the resource provider information is based on the receiving of the resource provider information response.

8. The method of claim 1, wherein the computing device is an communication device of a user, and wherein the communication device receives the one or more transaction elements from an authorizing entity computer.

9. The method of claim 1, wherein the computing device is an authorizing entity server providing a digital statement including the transaction.

10. The method of claim 9, wherein the authorizing entity server receives an authorization request for the transaction, prior to a completion of the transaction, and wherein the authorizing entity server authorizes the transaction, enabling the resource provider to complete the transaction.

11. A processing server for providing digital receipts, the processing server comprising:
a computer readable storage medium storing a plurality of instructions; and
one or more processors for executing the instructions stored on the computer readable storage medium to:
receive a digital receipt request from a computing device for a digital receipt associated with a transaction with a resource provider, the digital receipt request including one or more transaction elements associated with the transaction;
determine a resource provider identifier based on the one or more transaction elements;
obtain resource provider information associated with the resource provider using the resource provider identifier;
determine a receipt management server associated with the resource provider using the resource provider identifier;
send a receipt data request to the receipt management server, the receipt data request including the one or more transaction elements;
receive receipt data from the receipt management server;
generate a digital receipt element based on the resource provider information and the receipt data; and
send the digital receipt element to the computing device.

12. The processing server of claim 11, wherein the receipt data includes a plurality of data fields describing one or more goods or services associated with the transaction, wherein the digital receipt element is an image or image data object, and wherein the computer readable storage medium further stores instructions that cause the one or more processors to:
store the image or image data object; and
host a webpage for the digital receipt element, wherein the sending of the digital receipt element is performed via the webpage.

13. The processing server of claim 12, wherein the computer readable storage medium further stores instructions that cause the one or more processors to:
delete the image or image data object, after the sending of the digital receipt element, based on an expiration condition.

14. The processing server of claim 11, wherein the receipt data includes a plurality of data fields describing one or more goods or services associated with the transaction, and wherein the computing device is a mobile phone.

15. The processing server of claim 11, wherein the computing device provides a digital statement to a communication device of a user via a website or software application, wherein the computing device receives a selection of the transaction via a user interface of the website or software application, and wherein the computing device determines the one or more transaction elements based on a transaction identifier of the transaction.

16. The processing server of claim 11, wherein the computer readable storage medium further stores instructions that cause the one or more processors to:
determine a digital receipt capability of the resource provider using the resource provider identifier, the digital receipt capability indicating whether the resource provider is capable of providing digital receipts or is not capable of providing digital receipts, wherein the determining of the receipt management server and the sending of the receipt data request occur in response to the digital receipt capability indicating that the resource provider is capable of providing digital receipts.

17. The processing server of claim 11, wherein the computer readable storage medium further stores instructions that cause the one or more processors to:
send a resource provider information request to a data center, the resource provider information request including the resource provider identifier; and
receive a resource provider information response from the data center including the resource provider information, wherein the obtaining of the resource provider information is based on the receiving of the resource provider information response.

18. The processing server of claim 11, wherein the computing device is an communication device of a user, and wherein the communication device receives the one or more transaction elements from an authorizing entity computer.

19. The processing server of claim 11, wherein the computing device is an authorizing entity server providing a digital statement including the transaction.

20. The processing server of claim 19, wherein the authorizing entity server receives an authorization request for the transaction, prior to a completion of the transaction, and wherein the authorizing entity server authorizes the transaction, enabling the resource provider to complete the transaction.
